(19) United States
(12) Patent Application Publication
(10) Pub. No.: US 2006/0213926 A1
(43) Pub. Date: Sep. 28, 2006

(54) Multi-compartment dispensing container

(76) Inventors: Stephanie Kraus, Glendale, CA (US); Randal Ouye, La Crescenta, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/092,459

(22) Filed: Mar. 28, 2005

(51) Int. Cl. B67D 5/56

(52) U.S. Cl. 222/129

(57) ABSTRACT

A multi-compartment dispensing container includes multiple cells arranged around an axis. A common lid is provided. The cells each have an outlet port arranged substantially at the bottom, and each of these cells is isolated, one from the other, so that a substance can be in each cell independently of the other.

### RELATED APPLICATIONS

This application is related to U.S. Utility Patent Application filed on Mar. 28, 2005, entitled “CLEANING UTENSIL FOR A FLUID CONTAINER” (Docket No. 54317-040702, Express Mail Label No. EV 310 127 891 US); U.S. Utility Patent Application filed on Mar. 28, 2005, entitled “IRREGULAR SHAPED BABY BOTTLE” (Docket No. 54317-040703, Express Mail Label No. EV 310 128 905 US); U.S. Utility Patent Application filed on Mar. 28, 2005, entitled “A HANDLED DRINKING CONTAINER” (Docket No. 54317-040704, Express Mail Label No. EV 310 127 914 US); and U.S. Utility Patent Application filed on Mar. 28, 2005, entitled “BABY BOTTLE WITH ENLARGED LOWER PORTION” (Docket No. 54317-040705, Express Mail Label No. EV 310 127 928 US); all of which have been filed concurrently herewith. The contents of those applications are incorporated by reference herein.

### BACKGROUND

1. Field

This disclosure relates to a container for dispensing substances.

2. General Background

Different kinds of containers for dispensing substances are known. In particular, the substances are in the form of powders, such as baby formulas, and/or. alternatively the substances can be liquids and/or liquid-solid combinations. These known containers have different features and characteristics. None of these known containers have the advantages, utility and ergonomic characteristics which are desirable for situations such as permitting easy consumer use with good hygienic abilities. It is an object of this disclosure to provide a dispensing container with these advantages.

### SUMMARY

A dispensing container includes at least two cells for receiving substances. The cells are separated from each other. There is a closure for each cell and the closure is intended to be at a top location of the respective cells. An outlet for each cell is located towards the bottom of each cell. A lid for each cell secures the contents of each cell in an essentially leak-proof manner.

In one form, the inside face of the cells is relatively smooth without sharp corners, such that the substance can relatively easily exit the cells without getting stuck or clumping on the walls or other parts of the container.

Also, in a preferred form, the lid is common to the openings for the cells. The single lid permits for a large opening to the cells such that the substance can easily be introduced into the cells. As such, when the lid is removed, the access to all cells is obtained. In a preferred form, the cells are arranged about a central axis. Preferably, there are three cells radially arranged around the central axis. There is a common single lid which fits over all the cells.

In some preferred forms, the container is more or less circular, and the outlets are formed as feet for the container.

### DRAWINGS

The above-mentioned features and objects of the present disclosure will become more apparent with reference to the following description taken in conjunction with the accompanying drawings, wherein like reference numerals denote like elements, and in which:

FIG. 1 is a perspective view showing the lid above the compartments.

FIG. 2 is a top view of the container lid.

FIG. 3 is a side view of the container with one of the outlets opened.

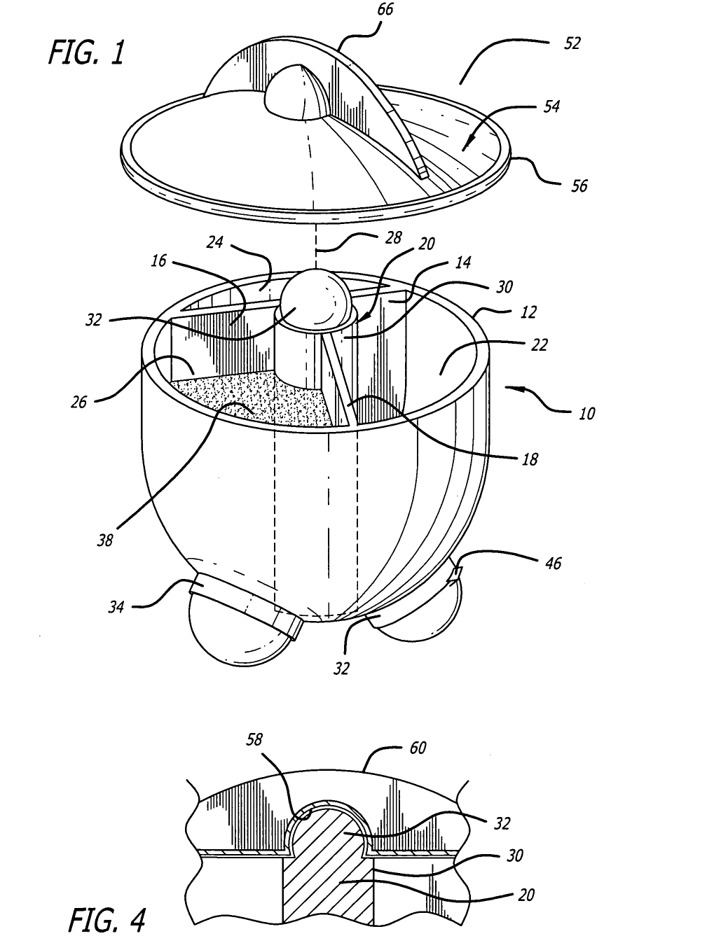

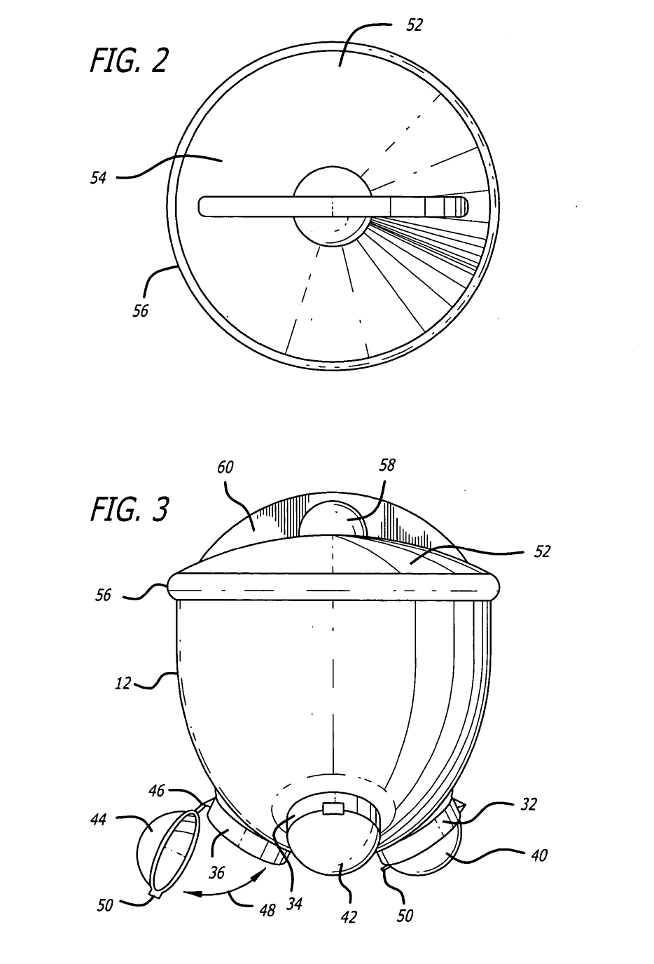

### DETAILED DESCRIPTION

The device is now described with reference to an example which is not to be considered as limiting. This is purely an illustration of the device.

One of ordinary skill in the art will understand that the present discussion is a description of exemplary embodiments only, and is not intended as limiting the broader aspects of the present disclosure, which broader aspects are embodied in the exemplary construction. A repeat use of reference characters in the present specification and drawings represents the same or analogous features or elements of the disclosure.

A multi-compartment container 10 includes a substantially circular sidewall 12 with divisions 14, 16 and 18 which are radially splayed out from a central core 20. As such, there are three compartments 22, 24 and 26 which are formed radially about a central axis 28. The core portion 20 includes an upstanding column 30 and on the topmost portion of the column, there is an essentially circular ball-like structure 32. The base of the column 20 is integrally formed with the sidewall 12 and mates with the base of the shell of the container.

Arranged circumferentially around the base or bottom area of the container are three outlets 32, 34 and 36. Each of these outlets includes an outlet port or spout from which the substance, in the form of baby formula powder, such as indicated by numeral 38 in any one of the cells, can exit from the respective cell when the respective outlet is opened. The substance can empty essentially completely from the container under gravity when the container is upright. Each of the ports 32, 34 and 36 has respectively a cap 40, 42 and 44 which is hinge mounted as indicated by numeral 46 so as to move between an open and closed position as indicated by arrow 48.

The inside face or wall of the container as defined by the cells is relatively smooth and formed to slope gradually towards the outlets when upstanding. The interface with the outlets is gradual and has the minimum of sharpness so as to facilitate the outflow of the powder for the cells when the outlets are opened.

When in the closed position, each of the cells is effectively closed such that substance cannot exit from the outlets. A finger grip 50 can be provided on the opposite side of the hinge if necessary to facilitate the release or otherwise of the cap from the closure port.

The lid 52 is provided with an essentially circular member 54 which has a rim 56 which engages on the outside of the wall 12 to retain a leak-proof configuration between the lid and the container for the cells. The opening to the cells is relatively large and essentially is formed by the perimeter wall of the cells.

The inside of the lid 52 has a hemispherical void 58 which mates with the hemispherical section 32 so that a positive engagement is attained when the lid 52 is put in place on the top of the wall 12 of the container. The outlet for each cell includes a movable cap. The cap inside forms essentially a hollow hemispherical shape such that in a closed position with formula in the cell, formula can fill part of the cap. When opened the formula can drain under gravity from the opened cap, and in this sense the opened cap is directed so as that the open hemisphere is downwardly directed.

Arranged in radial or diametric form over the hemispherical section 58 is a handle 60 which is radially directed from essentially one side of the lid to the other side of the lid. This permits for effective removal of the lid from the top of the container as necessary. The rim 56 may screw down on the top of the threaded section at the top of the container or alternatively an appropriate clip configuration can be used.

A unitary multi-compartmented dispensing container for a baby formula powder-like substance comprises three cells, each cell having an internal wall essentially sloping downwardly towards an outlet. The cells receive the baby formula, and each cell is separated from the other cell. The outlet for each cell is at a bottom of each cell. There is an interface between the wall for each cell and the outlet, and is such that the low point of the outlet interface and the base of the cell is substantially in horizontal alignment when the container is located in an upright position.

The walls of the container may be in part transparent and in part opaque. The transparency characteristic permits for outside visualization of the contents in the container.

The three cells can be pre-filled with baby formula and each, in turn, can be emptied through the respective outlets. Suitable indicia can be provided to permit a user to see visually the fullness of each cell. The outlets are of a nature such that effective draining under gravity is easily achieved. There can be more than three cells arranged around the central axis.

The feet outlet configurations provide a useful structure for ensuring the upright location of the container and at the same time a simple way to effect drainage of contents in the cells as needed. The configuration thus provides a dual purpose.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A unitary multi-compartmented dispensing container for substance comprising:
at least two cells, each cell being for receiving substance, and each cell being separated from the other cell;
a closure for each cell, the closure being intended to be at a top location of the respective cells;
an outlet for each cell, the outlet being for location at a bottom of each cell; and
a lid for each cell for securing the contents of each cell in an essentially leak-proof manner in each respective cell.

2. A container as claimed in claim 1, wherein the lid is common for all of the cells.

3. A container as claimed in claim 1, wherein the cells are located about a central axis.

4. A container as claimed in claim 1, wherein there are at least three cells, the cells being radially arranged about a central axis for the container.

5. A container as claimed in claim 4, including a hinged closure for the outlets, the hinge being located above the opening for the respective cells.

6. A container as claimed in claim 1, wherein the outlet for each cell constitutes a support leg for the container in that the container is locatable in an upright manner when located with each outlet directed downwardly, such that the substance can empty essentially completely from the container under gravity.

7. A container as claimed in claim 4, wherein the outlet for each cell constitutes a support leg for the container in that the container is locatable in an upright manner when located with each outlet directed downwardly.

8. A container as claimed in claim 5, wherein the outlet for each cell constitutes a support leg for the container in that the container is locatable in an upright manner when located with each outlet directed downwardly.

9. A unitary multi-compartmented dispensing container for a baby formula powder-like substance comprising:
at least two cells, each cell having an internal wall essentially sloping downwardly towards an outlet, each cell being for receiving the baby formula, and each cell being separated from the other cell;
a closure for each cell, the closure being intended to be at a top location of the respective cells;
an outlet for each cell, the outlet being for location at a bottom of each cell and an interface between the wall for each cell and the outlet being such that the low point of the outlet interface and the base of the cell is substantially in horizontal alignment when the container is located in an upright position; and
a lid for each cell for securing the contents of each cell in an essentially leak-proof manner in each respective cell.

10. A container as claimed in claim 9, wherein the lid is common for all of the cells.

11. A container as claimed in claim 10, wherein the cells are located about a central axis.

12. A container as claimed in claim 9, wherein the outlet for each cell constitutes a support leg for the container in that the container is locatable in an upright manner when located with each outlet directed downwardly, such that the substance can empty essentially completely from the container under gravity.

13. A container as claimed in claim 10, wherein the outlet for each cell constitutes a support leg for the container in that the container is locatable in an upright manner when located with each outlet directed downwardly, such that the substance can empty essentially completely from the container under gravity.

14. A container as claimed in claim 11, wherein the outlet for each cell constitutes a support leg for the container in that the container is locatable in an upright manner when located with each outlet directed downwardly, such that the substance can empty essentially completely from the container under gravity.

15. A container as claimed in claim 1, wherein the outlet for each cell includes a movable cap, the cap inside forming essentially a hollow hemispherical shape such that in a closed position with formula in the cell, formula can fill part of the cap.

16. A container as claimed in claim 9, wherein the outlet for each cell includes a movable cap, the cap inside forming essentially a hollow hemispherical shape such that in a closed position with formula in the cell, formula can fill part of the cap.
